(19) United States
(12) Patent Application Publication
(10) Pub. No.: US 2008/0035787 A1
(43) Pub. Date: Feb. 14, 2008

(54) Lighter-than-air gas handling system and method

(76) Inventor: Mark N. Thompson, Dewey, IL (US)

Correspondence Address: BRINKS HOFER GILSON & LIONE, P.O. BOX 10395, CHICAGO, IL, 60610, US

(21) Appl. No.: 11/501,608

(22) Filed: Aug. 8, 2006

(51) Int. Cl. B64B 1/58

(52) U.S. Cl. 244/97

(57) ABSTRACT

A lighter-than-air gas handling method and system for an airship capable of operating at a plurality of altitudes each characterized by a plurality of environmental conditions comprises a structure including a first envelope and a flexible volume portion in fluid communication with the first envelope. The first envelope capable of containing a volume of lighter-than-air gas disposed within the first envelope at a pressure in substantial equilibrium with an ambient pressure external to the first envelope when the airship is operating at a first altitude of the plurality of altitudes. A lighter-than-air gas transfer mechanism is coupled with the first envelope and the flexible volume portion and operative to allow the lighter-than-air gas to flow into the flexible volume portion as the lighter-than-air gas expands when the airship ascends to a second altitude higher than the first altitude and before the expanded lighter-than-air gas exceeds the containment capability of the first envelope. The flexible volume portion is operative to expand to accommodate the lighter-than-air gas flowing thereto from the first envelope wherein expansion of the flexible volume portion does not substantially affect the capability of the airship to operate in the plurality of environmental conditions of the second altitude. The lighter-than-air gas is transferred from the flexible volume portion into the first envelope as the airship descends from the second altitude to a third altitude lower than the second altitude.

### BACKGROUND

In conventional airships, a lighter-than-air gas or lifting gas is typically contained within one or more envelopes to provide lifting force which, alone or in combination with ballast and mechanical propulsion systems, is then used by the airship to ascend and/or descend to one or more operating altitudes, maintain those altitudes and then descend back to ground level. The constant lifting force provided by the lighter-than-air gas as well as its tendency to expand in volume as the airship ascends, and the ambient air pressure drops, and contract in volume as the airship descends, and the ambient air pressure increases, necessitates mechanisms to manage the lighter than air gas to maintain buoyancy and control of the airship and prevent the envelopes from rupturing.

One system for managing the lighter than air gas, such as for the purpose of controlling the buoyancy and altitude of conventional airships, implements the use of the ballast and bleed system for controlling buoyancy. In this system, ballast (e.g., sand) is added to the balloon payload. Dropping the ballast decreases the total mass of the balloon, causing the balloon to rise. Bleeding the lift gas (e.g., helium) causes the balloon to fall. With the ballast and bleed system, flights are limited to duration of a day or two because of the limited amount of ballast and extra lift gas that can be carried by the balloon. Nonetheless, ballast and bleed systems continue to attract the attention of inventors (e.g., U.S. Pat. No. 4,457,477, issued to Regipa, and U.S. Pat. No. 4,547,167, issued to Bergmann). Except in very rare circumstances, the ballast and bleed system is not suitable for long flights or continuous altitude control because of its substantial weight penalty and finite operating time.

In typical airship operations, ejecting ballast and releasing gas are often indispensable processes which occur during operation. In these types of airships, when the airship is started, i.e., takes off from ground level, ballast (usually water) is first ejected to allow a sufficiently fast climb to a particular altitude, such as about 50 to 100 meters, where the propulsion engines are started to bring the airship to its cruising altitude. As a result of decreasing air pressure with increasing altitude, the lifting gas in the existing envelope expands while the lifting force of the lift gas remains relatively constant. The lift, and therefore the airship's ascent, continues until the lifting force is lowered by releasing gas at the required altitude in order to keep equilibrium with the weight of the airship so that the airship can then continue to travel in the normal horizontal position. To descend, the airship generally cannot descend fast enough only through dynamic downward drift and a negative angle of incidence, so all that remains is to release gas and thereby decrease the lifting force.

In other types of airships, the fuel in the engine of the airship is combusted into gaseous products that escape into the atmosphere. The lost weight due to the combustion of the fuel creates an imbalance between the lifting force provided by the lighter-than-air gas and the weight of the airship that needs to be lifted. This necessitates compensating actions in order to maintain control, i.e. maintain a given rate of ascent or maintain a given altitude, corresponding to the lost weight of the combusted fuel. Typically this lost weight can only be compensated for by releasing lifting gas and thereby reducing the lifting force. For example, during a trip requiring 80 t, about 70,000 m³ of lifting gas is loss by releasing the lifting gas. Losing lifting gas of this magnitude becomes very expensive and financially unsupportable, especially when a costly gas like helium is used as the lifting gas.

Attempts to correct problems associated with excessive loss of lifting gas include conducting the exhaust gases of the engine through a cooling system in which the water of combustion condensed and entered into a ballast water tank to compensate quite precisely the weight lost through fuel consumption. However, the cooling system adds additional weight to the existing airship, and also adds additional costs resulting from the additional fuel consumption required to compensate for the weight increase of the airship. Additionally, this method requires the lifting gas to be compressed and stored in the ballast water tank to effectuate descent of the airship.

Alternatively, another system for managing the lighter than air gas, such as to minimize losses in airships, utilizes a ballast control method comprising onboard tanks of compressed liquefied lifting gas that is expelled into the airship through a heat exchanger as disclosed in U.S. Pat. No. 4,993,664. However, this type of system requires an onboard supply of liquefied lifting gas for ballast adjustment and also requires the purging of the lifting gas during descent of the airship. Thus, the airship has a limited supply of lifting gas that must be replenished and bound to the size limitations of the airship, which limits flight duration.

Yet another system for managing the lighter than air gas, such as to control the altitude in conventional airships, includes the use of a combination of a super-pressure envelope and a zero pressure envelope (e.g., U.S. Pat. Publication No. 20060000945). In this system, a gas transfer device is positioned between the envelopes to facilitate the transfer of lift gases that are lighter than air between the envelopes. The super-pressure envelope contains lifting gas a higher pressure than the ambient pressure, i.e. in a compressed state. The super-pressure envelope and the gas transfer device can be located inside the zero-pressure envelope. Alternatively, the zero-pressure envelope, the super-pressure envelope, and the gas transfer device can be located inside a zero-pressure envelope. Unfortunately, this system requires a mechanism to transfer the lighter-than-air gas to and from the super-pressure envelope and is further limited by the containment capability of the super-pressure envelope.

These and other lighter-than-air gas management systems all act to manage the lighter-than-air gas for the purpose of controlling the volume of, and thereby the lifting force exerted by, the lifting gas, whether to maintain altitude or control ascent and/or descent. However, none of these mechanisms allow for management of the lighter-than-air gas without affecting the buoyancy of the airship.

Accordingly, there is a need for an improved system and method of handling and managing a lighter-than-air gas of an airship that does not necessarily affect the buoyancy of the airship.

### BRIEF DESCRIPTION OF THE DRAWINGS

FIG. 1 is a front perspective view of an airship having a lighter-than-air gas handling system in accordance with one embodiment.

FIG. 2 is a front perspective view of the airship of FIG. 1, wherein a control system is coupled with the lighter-than-air gas transfer mechanism of the airship.

FIG. 3 is a front perspective view of the airship of FIG. 1, wherein a gondola is attached to the first envelope of the airship.

FIG. 4 is a top sectional view of the airship of FIG. 1 having a lighter-than-air-gas handling system according to one embodiment.

FIG. 5 is an alternate side sectional view of the airship of FIG. 1 according to one embodiment.

FIG. 6 is a perspective view of the airship of FIG. 5.

FIG. 7 is a perspective view of an alternative embodiment of the airship of FIG. 5, wherein the lighter-than-air gas handling system comprises a plurality of detachable members coupled with the airship.

FIG. 8 is a perspective view of an alternative embodiment of the airship of FIG. 5, wherein the lighter-than-air gas handling system comprises an ellipsoidal detachable member coupled with the airship.

FIG. 9 is a flow chart of a method of handling a lighter-than-air gas system in accordance with one embodiment.

### DETAILED DESCRIPTION OF EMBODIMENTS

Unless otherwise defined, all technical and scientific terms used herein have the same meaning as commonly understood by one of ordinary skill in the art to which this invention pertains. In case of conflict, the present document, including definitions, will control. Preferred methods and materials are described below, although methods and materials similar or equivalent to those described herein can be used in the practice or testing of the invention. The materials, methods, and examples disclosed herein are illustrative only and not intended to be limiting.

### Definitions

As used herein the terms “comprise(s),” “include(s),” “having,” “has,” “contain(s),” and variants thereof, are intended to be open-ended transitional phrases, terms, or words that do not preclude the possibility of additional acts or structure.

As used herein, the term “airship” means any air vessel that provides a housing structure to secure a lighter-than-air gas handling system, including but not limited to a blimp, fuselage, airfoil and spaceship.

As used herein, the term “environmental conditions” means any existing pressure, temperature, altitude, air density, wind conditions, humidity or other weather conditions, or combinations thereof, existing in nature.

As used herein, the term “coupled with” means directly connected to or indirectly connected through one or more intermediate components, including but not limited to the structure of the airship.

As used herein, the term “allow” means to occur naturally, or to occur using a pump mechanism, or combination thereof.

The following detailed description and appended drawings describe and illustrate various exemplary embodiments of the invention. The description and drawings serve to enable one skilled in the art to make and use the invention, and are not intended to limit the scope of the invention in any manner.

The present embodiments relate to a lighter-than-air gas transfer system and more particularly to an improved system for handling a lighter-than-air-gas of an airship that is capable of managing the lighter than air gas without necessarily affecting the buoyancy of the airship. The present embodiments provide a lighter-than-air gas handling method and system for an airship capable of operating at a plurality of altitudes each characterized by a plurality of environmental conditions. The disclosed system permits the lighter-than-air gas to expand as the airship expands without needing to vent the gas to the environment.

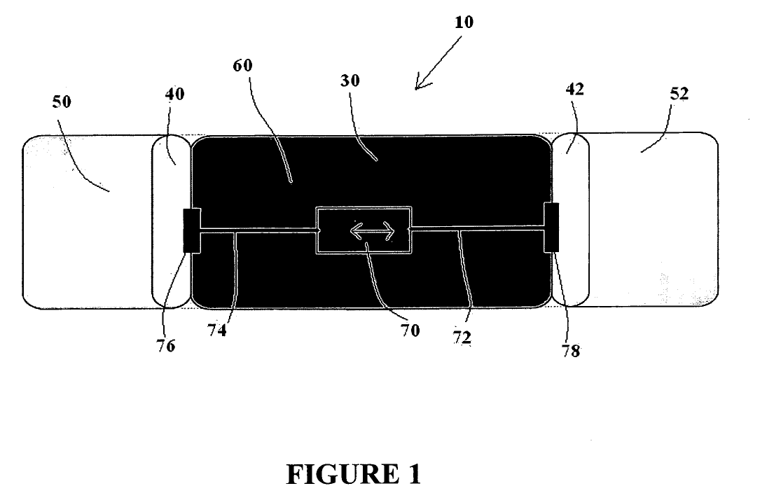

FIG. 1 shows a front perspective view of an airship having a lighter-than-air gas handling system 10 in accordance with one embodiment. In this embodiment, the lighter-than-air gas handling system 10 includes a first envelope 30, at least one enclosure 50, 52, at least one flexible volume portion 40, 42 each, for example, disposed within an enclosure 50, 52, a lighter-than-air-gas 60 disposed within the first envelope, and a lighter-than-air gas transfer mechanism 70 coupled with the first envelope and the flexible volume portions 40, 42.

An exemplary airship 10, to be constructed in accordance with the disclosed embodiments, is the TB-60 airship 10 to be manufactured by BlimpTech, Inc., located in Champaign, Ill. The TB-60 may be capable of speeds greater than 60 mph and carrying payloads in excess of 300 pounds. As will be described below, the TB 60 features an airfoil shape which allows for the addition of wing-tip tanks and/or for multiple TB-60 airships to be joined end-to-end, lengthening the overall airfoil structure, to increase payload capacity and/or flight duration. Additionally, a detachable and/or deflatable “hump-back” bladder/tank may be added to provide additional lift-gas, and thereby lifting force/static lift, such as 50-200 pounds of additional lift, and/or provide an additional reservoir for gas expansion, as will be described.

The TB-60 may be 60 feet long by 18 feet wide by 13 feet tall with a volume of 4500 cubic feet and a total lift of 290 pounds. The envelope weight is estimated to be 120 pounds, the gondola and tail feather weight is estimated to be 115 pounds and the buoyancy systems weight is estimated to be 30 pounds with a net payload dry of 25 pounds and a total payload dry of 275 pounds. With wingtip tanks, the TB-60 operating altitude is estimated to be 10,000 feet. Propulsion will be provided by three 14 kilowatt engines (210 cc each) each producing 100 pounds of thrust. It will be appreciated that the above specifications are estimates and that actual operating parameters of an airship constructed in accordance with the disclosed embodiments are dependent upon the implementation.

The disclosed embodiments harness and optimize the volatility of the lifting gas, e.g. helium, the expansion and contraction, and the variable lift that occurs at various air densities in relation to altitude and temperature. The disclosed embodiments contain the lifting gas through the use of wing tip tanks, i.e. a soft tank system that has external expansion and contraction abilities while maintaining a clean surface which ultimately limits the negative influence of drag, all achieved at a relatively low net gain in weight.

At 10,000 feet, it is estimated that there will be 28% expansion or a total gain of eleven feet; five-and-a-half feet per side of a cross-section of the envelope. Minimal mechanics provide for optimum containment of our gas—all this with an estimated loss in lift at roughly 6%.

In one embodiment, the first envelope 30 is a typical airship envelope of conventional construction and having an aerodynamic shape and light weight, such as an elliptical or elongate shape or, as will be discussed, an air-foil shape, and may contain both rigid and flexible structural elements. The first envelope 30 is constructed of a flexible and/or rigid substantially gas impermeable material, such as nylon or, alternatively, a carbon composite laminate, which is capable of containing the lighter-than-air-gas 60 disposed therein, at least when the airship is at a first altitude or range of altitudes, such as at ground level. It will be appreciated that the disclosed embodiments may be used with any suitably implemented first envelope 30 and that all such implementations are contemplated.

The lighter-than-air gas transfer mechanism 70 is located between the first envelope 30 and at least one of the flexible volume portions 40, 42 in fluid communication therewith and for facilitating the movement of the lighter-than-air gas 60 between the first envelope 30 and the flexible volume portions 40, 42 as will be described. It will be appreciated that the lighter-than-air gas transfer mechanism 70 may be located external to the first envelope 30 or elsewhere.

In one embodiment, a plurality of gas lines 72, 74 are interposed between the lighter-than-air gas transfer mechanism 70 and a plurality of connection fittings 76, 78, respectively, which are coupled with the flexible volume portions 40, 42. Specifically, the first connection fitting 76 is coupled with the first gas line 74 and the second connection fitting 78 is coupled with the second gas line 72 to allow the lighter-than-air gas 60 to move between the first envelope 30 and at least one of the flexible volume portions 40, 42. The enclosures 50, 52 are engaged to an airship 10 for disposing the flexible volume portions 40, 42 of the lighter-than-air gas handling system 10. Alternatively, the lighter-than-air gas transfer mechanism 70 may be coupled directly with either one or both of the flexible volume portions 40, 42 without the need of one or both of the gas lines 72, 74. In another alternative embodiment, multiple lighter-than-air gas transfer mechanisms 70 may be provided, each coupled with one or more of the flexible volume portions 40, 42, such as via gas lines 72, 74, or by another connection mode.

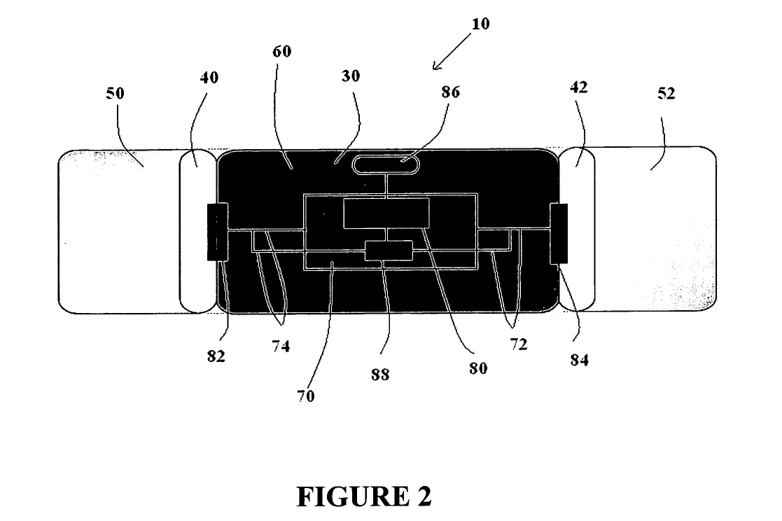

FIG. 2 shows a front perspective view of the airship 10 of FIG. 1, wherein a control system 80 is coupled with the lighter-than-air gas transfer mechanism 70 of the airship 10. The control system 80 of the lighter-than-air gas transfer mechanism 70 may include one or more pumps 88, valves 82, 84, gas lines 72, 74, sensor(s) 86, control mechanisms, or combinations thereof to implement the disclosed embodiments, as will be described.

The flexible volume portions 40, 42 include one or more envelopes which may be of similar or different construction as the first envelope 30. At a given altitude of the airship, such as at ground level, the flexible volume portions 40, 42 are disposed in a collapsed, deflated, unexpanded or otherwise evacuated state having substantially no interior volume and/or containing substantially no lighter-than-air gas 60 or other gases, such as air from the atmosphere. As described, the flexible volume portions 40, 42 are in fluid communication with the lighter-than-air gas transfer mechanism 70 which is coupled with the first envelope 30. In operation, the flexible portions 40, 42 expand, inflate, increase in volume or otherwise accommodate the expanded volume of lighter-than-air gas 60 as it expands within the first envelope 30, such as when the increased pressure, caused by the expansion of the lighter-than-air gas 60 as the airship 10 ascends, approaches or exceeds the containment capability of the first envelope 30. Conversely, the flexible portions 40, 42 deflate, contract, etc. as the volume of lighter-than-air gas 60 contracts and the pressure created thereby falls below the containment capability of the first envelope 30.

In one embodiment, the expansion and contraction of the flexible portions 40, 42 may take place within the enclosures 50, 52 in which the flexible portions are disposed. The enclosures 50, 52 are rigid structures coupled with the first envelope 30 which feature an interior cavity into which the flexible portions 40, 42 may expand. In this way, the expansion and/or contraction of the flexible portions 40, 42 does not affect the shape of the airship 10 and/or the aerodynamic capabilities thereof. Further, the rigid nature of the enclosures 50, 52, may permit the attachment of additional wing-tip tanks or other structures, including additional airships 10, to increase payload capacity and/or flight time, as was described. In an alternate embodiment, the flexible portions 40, 42 are disposed externally to the airship 10 such that the expansion and/or contraction of the flexible portions 40, 42 does change the airship 10 shape. In this embodiment, the flexible portions 40, 42 may be disposed in such a way so that the expansion or contraction thereof does not substantially alter the aerodynamic characteristics of the airship 10 for the particular environmental conditions in which the airship 10 is operating. For example, the expansion of the flexible portions 40, 42 may be configured so as to increase the width of the airship 10 having an airfoil shape, thereby merely lengthening the airfoil but not otherwise altering the profile. Additionally, at high altitudes, drag caused by the expansion of the flexible portions 40, 42 may be negligible due to the thinner atmosphere.

As the airship 10 ascends, the atmospheric/ambient pressure drops and the lighter-than-air gas 60 within the first envelope 30 expands. As the lighter-than-air gas 60 expands, the lighter-than-air gas transfer mechanism 70 monitors the expansion and, based thereon, allows the lighter-than-air gas 60 to flow to the one or more flexible portions 40, 42, such as before the pressure of the expanding lighter-than-air gas 60 approaches or exceeds the containment capability of the first envelope 30. In one embodiment, the lighter-than-air gas transfer mechanism includes pressure sensitive valves 82, 84, such as one-way valves, which are calibrated to allow the lighter-than-air gas 60 to flow from the first envelope 30 to the one or more flexible portions 40, 42 at a given gas pressure, such as a pressure less than the maximum pressure that may be contained by the first envelope 30, or within a margin thereof. Alternatively, the valves 82, 84 may be controlled, electrically, mechanically, pneumatically, etc. by the control system 80 of the lighter-than-air gas transfer mechanism 70, which in one embodiment may include a microprocessor or other digital and/or analog based controller, which is further coupled with the sensor(s) 86, such as pressure and/or altitude sensor(s), in communication with the first envelope 30. When the control system 80 senses, via the sensor(s) 86, that the pressure of the lighter-than-air gas 60 has reached a threshold value, such as the maximum containment pressure or a margin thereof, the control system 80 opens the valves 82, 84 to allow the lighter-than-air gas 60 to flow into the flexible portions 40, 42. Alternatively, the lighter-than-air gas transfer mechanism 70 may be coupled with the pump 88 or a mechanical, electrical or pneumatic compression mechanism, such as spring, bungee cord, or the like, under control of the control system 80 and/or sensor(s) 86, to actively transfer the lighter-than-air gas 60 to the flexible portions 40, 42 as the lighter-than-air gas 60 expands. As the lighter-than-air gas 60 flows into the flexible portions 40, 42, the flexible portions 40, 42 expand to accommodate the lighter-than-air gas 60, as described, and contain the lighter-than-air gas 60 at the given ambient pressure which is substantially the same as the pressure in the first envelope 30 and in equilibrium with the present environment in which the airship 10 is operating. As compared with conventional airships which would need to vent the expanded lighter-than-air gas 60 or otherwise store it in a compressed manner, the disclose embodiments conserve the expanded lighter-than-air gas 60 without complicated compression mechanisms and without affecting the airship 10 weight or buoyancy, as the total amount of lighter-than-air gas 60 within the airship 10 remains substantially unchanged.

As the airship 10 descends, the lighter-than-air gas 60 disposed within the first envelope 30 contracts. In conventional airships, the main envelope would begin to deflate as the gas therein contracted and the shape of the airship would change, likely in a detrimental way. In these conventional airships, ballonets, internal envelopes within the main envelope, would need to be inflated with outside air, since the excess lighter than air gas would have been vented upon ascent, to keep the main envelope inflated. In the disclosed embodiments, upon descent, the lighter-than-air gas 60 that was allowed to move to the flexible portions 40, 42 is transferred back to the first envelope 30 by the lighter-than-air gas transfer mechanism 70. In one embodiment, the pump 88 of the lighter-than-air gas transfer mechanism 70 actively transfers the lighter-than-air gas 60, such as under the control of the control system 80 and sensor(s) 86, from the flexible portions 40, 42 to the first envelope 30. The flexible portions 40, 42 may further include springs, bungee cords or other compression mechanisms to assist in collapsing, deflating, siphoning or otherwise evacuating the lighter-than-air gas 60 from the flexible portions 40, 42 and back to the first envelope 30. Thereby, the disclosed embodiments conserve the total amount of lighter-than-air gas 60 disposed within the airship 10.

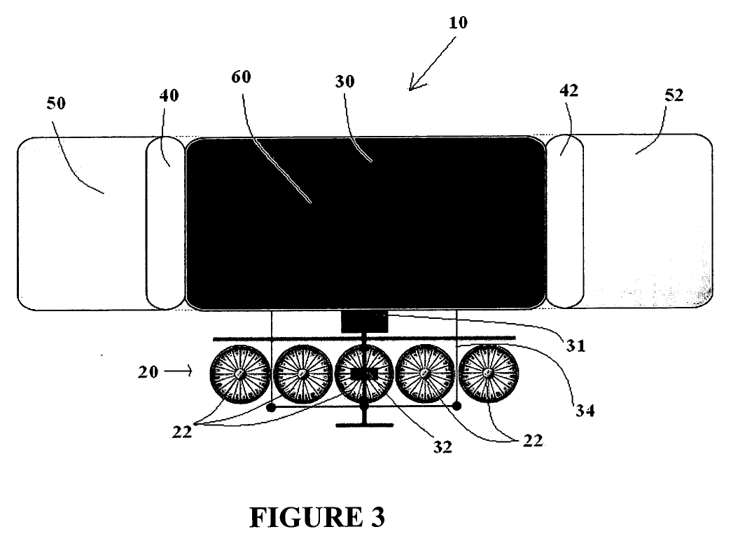

FIG. 3 shows a front perspective view of the airship of FIG. 1, wherein a gondola 20 is attached to the first envelope 30. The gondola 20 further includes a plurality of propellers 22 or other propulsion system for controlling movement of the airship 10. As will be apparent, the first envelope 30 and the gondola 20 are designed to carry a payload 34 secured to the first envelope 30.

As shown in FIG. 3, the propellers 22 are located in a side-by-side relationship. A reason for having multiple propellers 22 is that in case one fails, the other can continue to operate the airship 10. The propellers 22 are attached to the first envelope 30 by a connection that permits multiple axes of movement.

The gondola 20 is formed of two parts: an upper housing portion 31 and a lower housing portion 32. The upper housing portion 31 is connected to the lower side of the first envelope 30. The connection between the upper housing portion 31 and the first envelope 30 is fixed, i.e. the connection provides for no relative movement between the upper housing portion 31 and the first envelope 30. The lower housing portion 32 is rotatably connected to the upper housing portion 31. The gondola 20 may further include other components, such as a motor or similar electric power means, coupled with either the upper housing 31 or lower housing 32.

The payload 34 and the lighter-than-air gas transfer mechanism 70 are coupled with the first envelope 30 using the gas lines 72, 74 (see FIGS. 1-3). The gas lines 72, 74 connect the lighter-than-air gas transfer mechanism 70 to the inside of the first envelope 30. Optionally, the payload 34 and the lighter-than-air gas transfer mechanism 70 can be encased in foam or other material such that they will not cut or otherwise harm any envelope material that they contact.

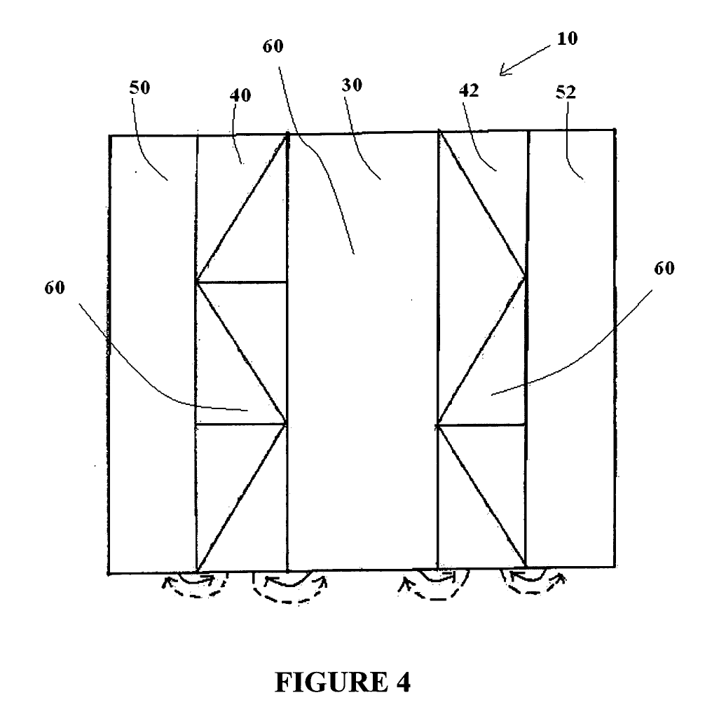

FIG. 4 shows a top sectional view of the airship of FIG. 1 having a lighter-than-air-gas handling system 10 according to one embodiment. In this embodiment, the lighter-than-air gas transfer mechanism 70 provides a fluid connection between the first envelope 30 and the flexible volume portions 40, 42. As was described above, the lighter-than-air gas transfer mechanism 70 may is in fluid communication with the first envelope 30. One skilled in the art will understand that there are many other possible devices that can be incorporated into the lighter-than-air gas transfer mechanism 70 of this embodiment. For example, lighter-than-air gas transfer mechanism 70 can include a blower, a fan, a turbine, a centrifugal pump, or any other device for passively allowing and/or actively transferring the lighter-than-air gas 60 between the first envelope 30 and the flexible portions 40, 42. Furthermore, the lighter-than-air gas transfer mechanism 70 may include a release valve (one way or two way) or any other device(s) capable of controlling a flow of lighter-than-air gas 60 within the airship 10.

### Ascent of the Airship Using the Lighter-than-Air Gas Handling System

In one embodiment, the lighter-than-air gas handling system for the airship 10 is capable of operating at a plurality of altitudes or range thereof, such as ground level, sea level, 10,000 ft, the edge of space, space, etc., each characterized by a plurality of environmental conditions, e.g. air pressure, humidity, temperature, wind speed, wind direction, solar radiation level, oxygen or other elemental gas level, or combinations thereof, wherein the airship 10 ascends and/or descends between the plurality of altitudes.

In this embodiment, the first envelope 30 is capable of containing a volume of lighter-than-air gas 60 disposed within the first envelope 30 at a pressure in substantial equilibrium with an ambient pressure external to the first envelope 30 when the airship 10 is operating at a first altitude of the plurality of altitudes. For example, where the first altitude is 100 feet above sea level, the first envelope 30 is capable of containing the lighter-than-air gas 60 at a pressure in substantial equilibrium with the ambient air pressure at that altitude, or a range of altitudes inclusive thereof. It will be appreciated that the volume of lighter-than-air gas 60 disposed within the first envelope 30 should be sufficient to fully inflate the first envelope 30 or otherwise satisfy the operational/aerodynamic needs of the airship 10. The flexible volume portions 40, 42 are substantially devoid of the lighter-than-air gas 60 when the airship 10 is at the first altitude. For example, when the first altitude is equivalent to ground level, the airship is released into the atmosphere with the first envelope 30 filled with a predetermined volume of lighter-than-air gas 60 and the flexible volume portions 40, 42 are substantially devoid of any lighter-than-air gas 60. In addition, the first envelope 30 can be partially inflated or fully inflated for launch depending on the specifications of the particular airship 10. In an alternate implementation wherein the airship 10 is deployed at a high altitude, such as by rocket to the space or the edge of space, the first envelope 30 and flexible portions 40, 42 may be both fully, or partially inflated, such as from a compressed source of lighter-than-air gas 60, so that as the airship 10 descends and the volume of gas 60 in the first envelope 30 decreases, the gas 60 located in the flexible portions 40, 42 may be utilized to maintain inflation of the first envelope 30 according to the disclosed embodiments.

The lighter-than-air gas transfer mechanism 70 is operative to allow the lighter-than-air gas 60 to flow into at least one of the flexible volume portions 40, 42 as the lighter-than-air gas 60 expands when the airship 10 ascends to a second altitude higher than the first altitude and before the expanded lighter-than-air gas 60 exceeds the containment capability of the first envelope 30. During ascent of the airship 10, the flexible volume portions 40, 42 are operative to expand or otherwise increase in volume and accommodate the lighter-than-air gas 60 flowing thereto from the first envelope 30. In one embodiment, the expansion of the flexible volume portions 40, 42 does not substantially affect the capability of the airship 10 to operate in the plurality of environmental conditions of the second altitude. For example, the flexible portions 40, 42 may be contained within enclosures 50, 52 having a rigid external shape. Alternatively, the flexible volume portions 40, 42 may take on an aerodynamically efficient, such as for the particular operating altitude, shape as they expand.

When the airship 10 descends from the second altitude to a third altitude lower than the second altitude, the lighter-than-air gas 60 is transferred from the flexible volume portion into the first envelope 30. The flexible volume portions 40, 42 may then be contracted when the lighter-than-air gas 60 is transferred from the flexible volume portions 40, 42 into the first envelope 30.

In another example, as described above, the airship 10 may ascend from a third altitude wherein the third altitude is above sea level. The airship 10 is released from the third altitude into the atmosphere with the first envelope 30 filled with a predetermined volume of gas and the flexible volume portions 40, 42 at least partially filled with lighter-than-air gas 60. In this example, when the airship 10 ascends to a fourth altitude higher than the third altitude, the lighter-than-air gas handling system 10 operates by allowing lighter-than-air gas 60 to move from the first envelope 30 into the flexible volume portions 40, 42 of the system 10. Regardless of the height of the altitude that the airship 10 is launched, the system 10 operates efficiently to maintain the altitude of the airship 10 on land, sea or air without exceeding the containment capability of the first envelope 30.

### Descent of the Airship Using the Lighter-than-Air Gas Handling System

In another embodiment, the lighter-than-air gas handling system 10 for the airship 10 is capable of operating at a plurality of altitudes each characterized by a plurality of environmental conditions, wherein the airship 10 descends between the plurality of altitudes.

In this embodiment, the first envelope 30 is capable of containing a volume of lighter-than-air gas 60 disposed within the flexible volume portions 40, 42 at a pressure in substantial equilibrium with an ambient pressure external to the flexible volume portions 40, 42 and at a volume capable of being contained by the flexible volume portions 40, 42 when the airship 10 is operating at a first altitude of the plurality of altitudes. For example, when the first altitude is at a height above ground level, the airship may be released into the atmosphere with the flexible volume portions 40, 42 at least partially filled with a predetermined volume of lighter-than-air gas 60 and the first envelope 30 may be substantially devoid of lighter-than-air gas 60 or filled with an amount suitable for operation at the altitude of deployment.

The lighter-than-air gas transfer mechanism 70 is operative to transfer the lighter-than-air gas 60 into the first envelope 30 as the lighter-than-air gas 60 contracts when the airship 10 descends to a second altitude lower than the first altitude and before the pressure of the contracted lighter-than-air gas 60 falls substantially below the ambient pressure, such as before the first envelope substantially deflates. During descent of the airship 10, the first envelope 30 is operative to expand or otherwise maintain its containment volume to accommodate the lighter-than-air gas 60 flowing thereto from the flexible volume portions 40, 42. The pressure of the lighter-than-air gas 60 within the first envelope 30 is maintained so as not to substantially affect the capability of the airship 10 to operate in the plurality of environmental conditions of the second altitude.

When the airship 10 ascends from the second altitude to a third altitude higher than the second altitude, the lighter-than-air gas 60 is allowed to flow from the first envelope 30 into the flexible volume portions 40, 42. Additionally, the flexible volume portions 40, 42 are expanded when the lighter-than-air gas 60 is allowed to flow from the first envelope into the flexible volume portions 40, 42. In one embodiment, the flexible volume portions 40, 42 are secured in a lumen of the enclosures 50, 52 during expansion.

Similar to descent, the system 10 operates efficiently to maintain the descent altitude of the airship on land, sea or air without exceeding the containment capability of the first envelope 30.

### Alternate Embodiments of the Lighter-than-Air Gas Handling System

In an alternative embodiment (see FIG. 2), the lighter-than-air gas transfer mechanism 70 may comprise one or more valves 82, 84 or sensor(s) 86 operative to allow the lighter-than-air gas 60 to flow from the first envelope 30 into the flexible volume portions 40, 42 at a predetermined pressure. In addition, the sensor(s) 86 may be coupled with the first envelope 30 and the valves 82, 84, wherein the sensor(s) 86 is operative to detect the pressure of the lighter-than-air gas 60 contained within the first envelope 30 and control the valves 82, 84 in response thereto. Likewise, the lighter-than-air gas handling system 10 may comprise a compression mechanism coupled with the first envelope 30 and the flexible volume portions 40, 42 to maintain the pressure in the first envelope 30, the flexible volume portions 40, 42, or both, when the lighter-than-air gas 60 flows between the first envelope 30 and the flexible volume portions 40, 42. Other embodiments may comprise transferring the lighter-than-air gas 60 by exerting pressure on a surface of the flexible volume portions 40, 42.

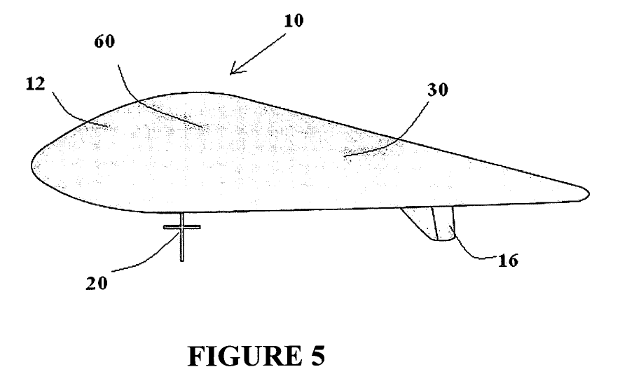

FIG. 5 shows an alternate side sectional view of the airship of FIG. 1 according to one embodiment having the lighter-than-air gas handling system 10 coupled with the airship 10. The airship 10 provides an elongate structure for containing the components of the system 10, such as the first envelope 30. In addition, a gondola 20 is coupled with the structure of the airship 10, along with a rudder 16 coupled with a tail end of the airship 10. The rudder 16 aids in the maneuvering of the airship 10 during the use of the lighter-than-air gas handling system 10 (see FIG. 5).

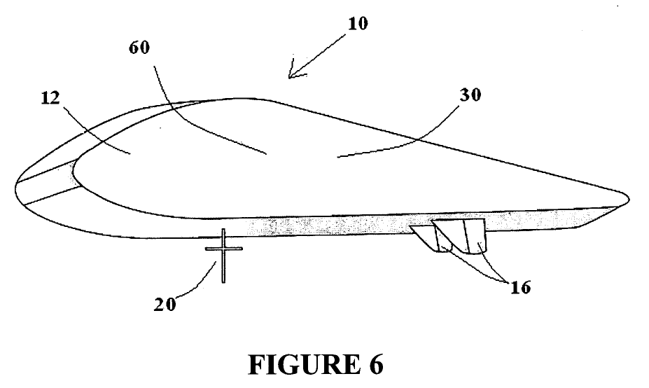

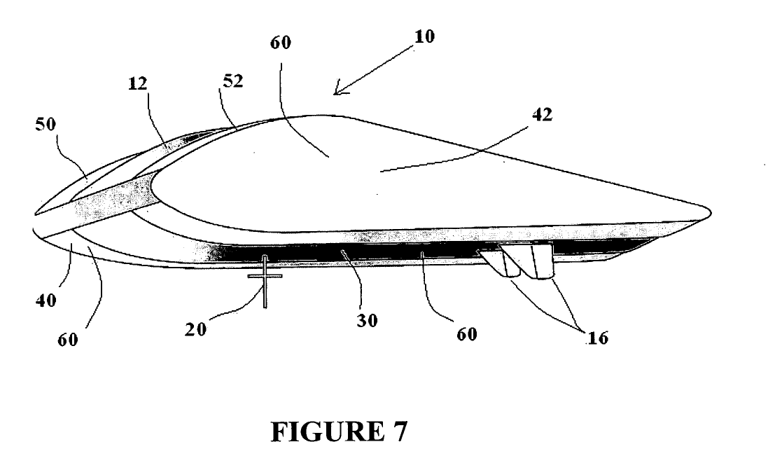

FIGS. 6-7 show perspective views of the alternative embodiment of the airship of FIG. 5. In the embodiment shown in FIG. 6, the lighter-than-air gas handling system 10 comprises a plurality of enclosures 50, 52 coupled with the airship 10. The enclosures 50, 52 may be detachably coupled with the body of the airship 10 and may be detached and reattached during or after flight of the airship 10. Additionally, when the flexible volume portions 40, 42 are expanded as a result of being inflated with lighter-than-air gas 60, the enclosures 50, 52 protect the flexible volume portions 40, 42 from existing environmental conditions.

One skilled in the art will recognize that alternate embodiments can comprise a lighter-than-air gas handling system 10 comprising a plurality of envelopes and a plurality of flexible portions. For example, a lighter-than-air gas handling system 10 comprising a second and third envelope attached to a plurality of flexible volume portions may be used. Alternatively, the airship 10 may include an ellipsoid or “blimp” shape divided longitudinally, vertically or horizontally, substantially in half with each half comprising an envelope 30, with one or more flexible volume portions 40, 42 disposed therebetween and a transfer mechanism 70 as described. As the flexible volume portion(s) 40, 42 expand, the airship 10 gets taller or wider, depending on the implementation, as the two halves/envelopes 30 diverge. In yet another alternative embodiment, the airship 10 may include two or more separate first envelopes 30, each, for example, having a “blimp” or ellipsoidal shape, and being interconnected by a cross-bar or other interconnection featuring the disclosed lighter-than-air gas transfer system. The cross-bar may feature an airfoil or other aerodynamic shape. In this embodiment, one or more flexible volume portions 40, 42 may be disposed within or as part of the cross-bar. In operation, wherein the flexible portions 40, 42, are disposed within the cross-bar, they operate as described, expanding or contracting as necessary, within the cross-bar structure which acts similarly to the enclosures 50, 52 described herein, to accommodate the gas 60 expansion or contraction. In embodiments wherein the flexible portions 40, 42 form part of the cross-bar, the cross bar may increase or contract in length, or other dimension, as the flexible portion(s) 40, 42 expand or contract as described. It will be appreciated that embodiments having multiple first envelopes 30 interconnected by multiple cross-bars/interconnections featuring the disclosed lighter-than-air gas management system may be implemented.

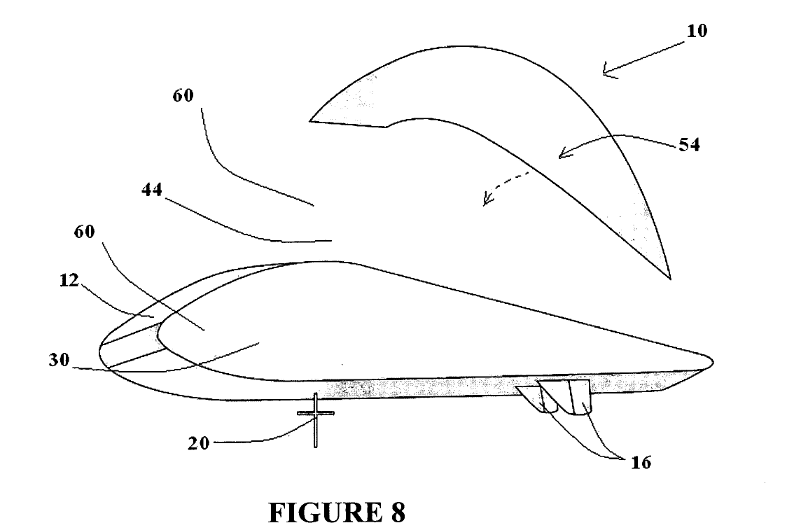

FIG. 8 shows a perspective view of an alternative embodiment of the airship of FIG. 5, wherein the lighter-than-air gas handling system 10 comprises an auxiliary ellipsoidal or “humpback” envelope 54, or external tank, coupled with the airship 10. In one embodiment the auxiliary envelope 54 is detachably coupled with the airship 10. The envelope 54 provides additional storage for additional lighter-than-air gas 60 to provide additional static lift, and thereby increased payload capacity and/or flight duration, and/or as additional expansion space, as described herein.

Unlike conventional airship designs, when the lighter-than-air gas 60 is allowed to flow from the first envelope 30 into a flexible volume portion 44 having an ellipsoidal shape. The lighter-than-air gas 60 expands when the airship 10 ascends to a second altitude higher than the first altitude and before the expanded lighter-than-air gas 60 exceeds the containment capability of the first envelope 30. The lighter-than-air gas 60 flows into the flexible volume portion 44 wherein the ellipsoidal shape of the flexible portion 44 further allows the flexible portion 44 to be secured in the auxiliary envelope 54. The configuration of the auxiliary envelope 54 also provides a reservoir for the expanded lighter-than-air gas. The auxiliary envelope 54 can also be detached and recovered during flight of the airship 10.

The lighter-than-air gas 60 of the system 10 may comprise any suitable gas capable of expansion and contraction between the first envelope 30 and the flexible volume portions 40, 42, including but not limited to helium, hydrogen, methane, ammonia, hot air, and other gases known in the art.

The composition of the materials used in the components of the lighter-than-air gas handling system 10 can include polyethylene, nylon, latex, rubber, composite laminate or other suitable materials having reasonable strength, durability and retention characteristics. For example, the flexible volume portions 40, 42 can comprise polyethylene, wherein the first envelope comprises a latex material. Additionally, the flexible volume portions 40, 42 and the first envelope 30 can be constructed from any material suitable for expansion and contraction during flight of the airship 10 in environmental conditions. Additionally, the flexible volume portions 40, 42 and the first envelope 30 may include varying shapes and configurations, including but not limited to spherical, circular, ellipsoidal or any variations thereof.

The components of the lighter-than-air gas handling system 10, such as the flexible volume portions 40, 42 and the first envelope 30, can also include variations of thickness and diameter depending on the design and configuration of the airship 10. A preferred range of thickness is between about 0.0025 to 0.05 millimeters. However, any range of thicknesses suitable for expansion and contraction between the flexible volume portions 40, 42 and the first envelope 30 may be used. Furthermore, the flexible volume portions 40, 42 and the first envelope 30 may comprise a coating to maintain pressure and/or temperature in environmental conditions.

In other embodiments, the airship 10 may comprise other configurations and elongate structures providing a housing for the components of the lighter-than-air gas handling system 10, such as a fuselage, airfoil and a blimp. In general the airship 10 may also include a variety of shapes, including but not limited to rectangular, circular, triangular, ellipsoidal and parabolic. For example, the airship 10 may comprise a fuselage having a circular shape.

In another embodiment, the lighter-than-air gas 60 of the lighter-than-air gas handling system 10 may expand and contract as a result of temperature changes in environmental conditions. For instance, the first envelope 30 may contain a volume of lighter-than-air gas 60 disposed within the first envelope 30 at a temperature in substantial equilibrium with an ambient temperature external to the first envelope 30 when the airship 10 is operating at a first altitude of the plurality of altitudes.

Thus, when the temperature increases, such as during daytime use, under clear skies or at high altitudes, the lighter-than-air gas 60 expands and is allowed to move from the first envelope 30 into the flexible volume portions 40, 42. Likewise, when the temperature decreases, such as during nighttime, cloudy weather or at lower altitudes, the lighter-than-air gas 60 contracts and is transferred from the flexible volume portions 40, 42 into the first envelope 30.

In other words, the lighter-than-air gas handling system 10 will maintain the lighter-than-air gas 60 as close as possible to ambient temperature at all times and provides optimal function throughout any temperature variation in environmental conditions. Other means of minimizing heating and cooling of between the first envelope 30 and the flexible portions 40, 42, such as, but not limited to, constructing the first envelope 30 and the flexible portions 40, 42 with transparent materials, alternating the design configurations of the first envelope 30 and the flexible portions 40, 42, and insulating the material of the first envelope 30 and the flexible portions 40, 42, will be apparent to those skilled in the art.

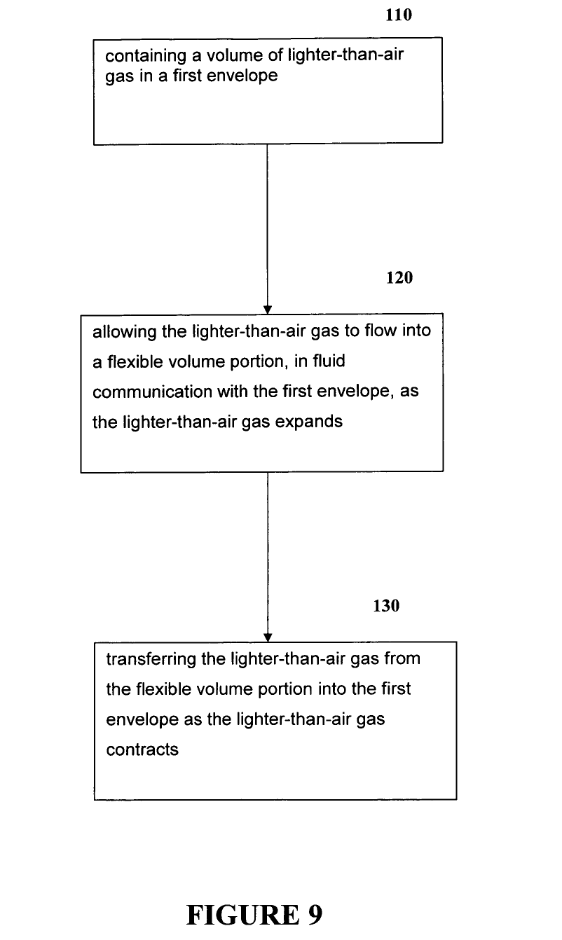

FIG. 9 shows a flow chart of a method of handling a lighter-than-air gas system 10 in accordance with one embodiment. The method includes the step 110 of containing a volume of lighter-than-air gas 60 at a pressure in substantial equilibrium with an ambient pressure external to a first envelope 30 when the airship 10 is operating at a first altitude of the plurality of altitudes.

The method further includes the step 120 of allowing the lighter-than-air gas 60 to flow into a flexible volume portion 40, 42, in fluid communication with the first envelope 30, as the lighter-than-air gas expands and before the expanded lighter-than-air gas exceeds the containment capability of the first envelope 30. The flexible volume portion 30 expands to accommodate the lighter-than-air gas 60 flowing thereto from the first envelope 30 and the expansion of the flexible volume portion 40, 42 does not substantially affect the capability of the airship 10 to operate in the plurality of environmental conditions. The method can also include the step 130 of transferring the lighter-than-air gas 60 from the flexible volume portion 40, 42 into the first envelope 30 as the airship 10 descends from the second altitude to a third altitude lower than the second altitude.

Another embodiment comprises a lighter-than-air gas handling system for an airship capable of operating at a plurality of altitudes each characterized by a plurality of environmental conditions comprising a means for containing a volume of lighter-than-air gas 60 at a pressure in substantial equilibrium with an ambient pressure external to the means for containing when the airship 10 is operating at a first altitude of the plurality of altitudes. The system 10 also comprises a means for allowing the lighter-than-air gas 60 to flow into a flexible volume means, in fluid communication with the means for containing, as the lighter-than-air gas 60 expands and before the expanded lighter-than-air gas 60 exceeds the containment capability of the means for containing. The flexible volume means of the system comprising means for expanding to accommodate the lighter-than-air gas 60 flowing thereto from the means for containing. In addition, the expansion of the flexible volume means does not substantially affect the capability of the airship 10 to operate in the plurality of environmental conditions.

While the disclosed lighter-than-air gas transfer system may be utilized with any airship 10 having a variety of propulsion mechanisms, the disclosed system may especially useful in airships 10 having solar or electric propulsion systems, where the consumption of energy does not result in a net change in the weight, and thereby the buoyancy, of the airship 10. In gas powered airships 10, as the fuel is consumed, the overall weight of the airship 10 decreases due to the lost weight of the consumed fuel. In order to maintain the requisite buoyancy, e.g. to maintain altitude/neutral buoyancy or rate of climb or descent, it may be necessary to vent some of the lighter-than-air gas 60, despite the provision of the disclosed system. Accordingly, the flight duration of such airships 10 may be limited due to lost gas 60, especially if they need to be able to ascend and descend many time during the flight.

However, where the airship 10 uses a solar, battery, electric or otherwise a propulsion system wherein the consumption of energy by the propulsion system does not substantially alter the weight of the airship 10, the disclosed gas management system may permit the airship 10 to remain aloft for a significantly increased time, even where the airship 10 must make multiple altitude changes during flight. Given that there is no need to vent gas 60 to control buoyancy, the disclosed system further obviates any remaining need to vent gas 60 due to expansion.

While the invention has been illustrated and described in detail in the drawings and foregoing description, the same is to be considered as illustrative and not restrictive in character, it being understood that only exemplary embodiments have been shown and described and do not limit the scope of the invention in any manner. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

We claim:

1. A lighter-than-air gas handling system for an airship capable of operating at a plurality of altitudes each characterized by a plurality of environmental conditions, the system comprising:
a structure including a first envelope and a flexible volume portion in fluid communication with the first envelope, the first envelope capable of containing a volume of lighter-than-air gas disposed within the first envelope at a pressure in substantial equilibrium with an ambient pressure external to the first envelope when the airship is operating at a first altitude of the plurality of altitudes; and
a lighter-than-air gas transfer mechanism coupled with the first envelope and the flexible volume portion and operative to allow the lighter-than-air gas to flow into the flexible volume portion as the lighter-than-air gas expands when the airship ascends to a second altitude higher than the first altitude and before the expanded lighter-than-air gas exceeds the containment capability of the first envelope, the flexible volume portion operative to expand to accommodate the lighter-than-air gas flowing thereto from the first envelope.

2. The system of claim 1, wherein expansion of the flexible volume portion does not substantially affect the capability of the airship to operate in the plurality of environmental conditions of the second altitude.

3. The system of claim 1, wherein the flexible volume portion is substantially devoid of the lighter-than-air gas when the airship is at the first altitude.

4. The system of claim 1, wherein the lighter-than-air gas transfer mechanism comprises a valve operative to allow the lighter-than-air gas to flow from the first envelope into the flexible volume portion at a predetermined pressure.

5. The system of claim 4, further comprising a sensor coupled with the first envelope and the valve, the sensor operative to detect the pressure of the lighter than air gas contained within the envelope and control the valve in response thereto.

6. The system of claim 1, wherein the lighter-than-air gas is transferred from the flexible volume portion into the first envelope as the airship descends from the second altitude to a third altitude lower than the second altitude.

7. The system of claim 6, wherein the flexible volume portion is contracted when the lighter-than-air gas is transferred from the flexible volume portion into the first envelope.

8. The system of claim 6, wherein the lighter-than-air gas is transferred by applying pressure to a surface of the flexible volume portion.

9. The system of claim 1, wherein the lighter-than-air gas transfer mechanism comprises at least one of a pump, valve, spring, bungee cord, or combinations thereof.

10. The system of claim 1, further comprising a compression mechanism coupled with the first envelope and the flexible volume portion to maintain the pressure when the lighter-than-air gas flows from the first envelope into the flexible volume portion.

11. The system of claim 1, wherein the lighter-than-air gas comprises helium.

12. The system of claim 1, wherein the lighter-than-air gas comprises hydrogen.

13. The system of claim 1, wherein the structure comprises a fuselage for disposing the first envelope of the lighter-than-air gas handling system.

14. The system of claim 1, wherein the structure comprises an airfoil for disposing the first envelope of the lighter-than-air-gas handling system.

15. The system of claim 1, further comprising one or more detachable members engaged to the airship for disposing the flexible volume portion of the lighter-than-air gas handling system.

16. The system of claim 15, wherein when the flexible volume portion expands, the flexible volume portion is secured within a lumen of the one or more detachable members.

17. The system of claim 15, wherein the one or more detachable members reduce drag of the airship to maximize the duration of flight in the plurality of environmental conditions.

18. The system of claim 15, wherein the one or more detachable members comprise a shape selected from the group consisting of rectangular, triangular, spherical, ellipsoidal, and parabolic.

19. A lighter-than-air gas handling system for an airship capable of operating at a plurality of altitudes each characterized by a plurality of environmental conditions, the system comprising:
a structure including a first envelope and a flexible volume portion in fluid communication with the first envelope, the flexible volume portion capable of containing a volume of lighter-than-air gas disposed within the flexible volume portion at a pressure in substantial equilibrium with an ambient pressure external to the flexible volume portion when the airship is operating at a first altitude of the plurality of altitudes; and
a lighter-than-air gas transfer mechanism coupled with the first envelope and the flexible volume portion and operative to transfer the lighter-than-air gas into the first envelope as the lighter-than-air gas contracts when the airship descends to a second altitude lower than the first altitude and before the pressure of the contracted lighter-than-air gas falls substantially below the ambient pressure, the first envelope operative to accommodate the lighter-than-air gas flowing thereto from the flexible volume portion.

20. The system of claim 19, wherein the pressure of the lighter than air gas within the first envelope is maintained so as not to substantially affect the capability of the airship to operate in the plurality of environmental conditions of the second altitude.

21. The system of claim 19, wherein the lighter-than-air gas transfer mechanism comprises a one way valve to transfer the lighter-than-air gas from the flexible volume portion into the first envelope at a predetermined pressure.

22. The system of claim 21, further comprising a sensor controlled mechanism to open the one way valve when the flexible volume portion reaches the predetermined pressure.

23. The system of claim 19, wherein the lighter-than-air gas is allowed to flow from the first envelope into the flexible volume portion as the airship ascends from the second altitude to a third altitude higher than the second altitude.

24. The system of claim 23, wherein the flexible volume portion is expanded when the lighter-than-air gas is allowed to flow from the first envelope into the flexible volume portion.

25. The system of claim 19, wherein the structure comprises a fuselage for disposing the first envelope of the lighter-than-air gas handling system.

26. The system of claim 19, wherein the structure comprises an airfoil for disposing the first envelope of the lighter-than-air-gas handling system.

27. The system of claim 19, further comprising one or more detachable members engaged to the airship for disposing the flexible volume portion of the lighter-than-air gas handling system.

28. The system of claim 27, wherein when the flexible volume portion contracts, the flexible volume portion is secured within a lumen of the one or more detachable members.

29. The system of claim 27, wherein the one or more detachable members reduce drag of the airship to maximize the duration of flight in environmental conditions.

30. The system of claim 27, wherein the one or more detachable members comprise a shape selected from the group consisting of rectangular, triangular, spherical, ellipsoidal, and parabolic.

31. A method of handling a lighter-than-air gas system for an airship capable of operating at a plurality of altitudes each characterized by a plurality of environmental conditions, the method comprising:
containing a volume of lighter-than-air gas at a pressure in substantial equilibrium with an ambient pressure external to a first envelope when the airship is operating at a first altitude of the plurality of altitudes; and
allowing the lighter-than-air gas to flow into a flexible volume portion, in fluid communication with the first envelope, as the lighter-than-air gas expands and before the expanded lighter-than-air gas exceeds the containment capability of the first envelope.

32. The method of claim 31, wherein expansion of the flexible volume portion does not substantially affect the capability of the airship to operate in the plurality of environmental conditions of the second altitude.

33. The method of claim 31, wherein the flexible volume portion is substantially devoid of the lighter-than-air gas when the airship is at the first altitude.

34. The method of claim 31, wherein the lighter-than-air gas transfer mechanism comprises a one way valve to allow the lighter-than-air gas to flow from the first envelope into the flexible volume portion at a predetermined pressure.

35. The method of claim 31, further comprising the step of providing a sensor controlled mechanism to open the one way valve when the first envelope reaches the predetermined pressure.

36. The method of claim 31, further comprising the step of transferring the lighter-than-air gas from the flexible volume portion into the first envelope as the airship descends from the second altitude to a third altitude lower than the second altitude.

37. The method of claim 31, further comprising the step of providing one or more detachable members engaged to the airship for disposing the flexible volume portion of the lighter-than-air gas handling system.

38. A lighter-than-air gas handling system for an airship capable of operating at a plurality of altitudes each characterized by a plurality of environmental conditions, the system comprising:
means for containing a volume of lighter-than-air gas at a pressure in substantial equilibrium with an ambient pressure external to the means for containing when the airship is operating at a first altitude of the plurality of altitudes; and
means for allowing the lighter-than-air gas to flow into a flexible volume means, in fluid communication with the means for containing, as the lighter-than-air gas expands and before the expanded lighter-than-air gas exceeds the containment capability of the means for containing, the flexible volume means comprising means for expanding to accommodate the lighter-than-air gas flowing thereto from the means for containing.

39. The system of claim 38, wherein expansion of the flexible volume means does not substantially affect the capability of the airship to operate in the plurality of environmental conditions.

40. The system of claim 38, further comprising means for transferring the lighter-than-air gas from the flexible volume means into the means for containing as the airship descends from the second altitude to a third altitude lower than the second altitude.
